(19) United States
(12) Patent Application Publication
(10) Pub. No.: US 2026/0029504 A1
(43) Pub. Date: Jan. 29, 2026

(54) HYBRID FIRA-OMLOX DOWNLINK TIME DIFFERENCE OF ARRIVAL STRUCTURE FOR ULTRA-WIDE BAND RANGING

(71) Applicant: Cisco Technology, Inc., San Jose, CA (US)

(72) Inventors: Jerome Henry, Pittsboro, NC (US); Ardalan Alizadeh, Milpitas, CA (US); Peiman Amini, Fremont, CA (US)

(21) Appl. No.: 19/203,517

(22) Filed: May 9, 2025

Related U.S. Application Data
(60) Provisional application No. 63/675,857, filed on Jul. 26, 2024.

(51) Int. Cl. G01S 5/02; G01S 3/18; G01S 13/02; H04W 64/00

(52) U.S. Cl. CPC G01S 5/02213; G01S 3/18; G01S 5/0284; G01S 13/0209; H04W 64/006

(57) ABSTRACT

The present disclosure is directed to signaling procedures for enabling co-existence of omlox and FiRa UWB standards. In one aspect, a method includes determining, for each of a plurality of ranging blocks to be used by one of a plurality of anchors in a hybrid FiRa-omlox environment, a corresponding rounding split between corresponding idle ranging rounds and active ranging rounds, the plurality of anchors including at least one FiRa-compatible anchor and at least one omlox-compatible anchor; generating each of the plurality of ranging blocks using the corresponding rounding split; and sending the plurality of ranging blocks to the plurality of anchors.

### CROSS-REFERENCE TO RELATED APPLICATIONS

This application is a continuation of U.S. Provisional Patent Application No. 63/675,857, filed Jul. 26, 2024, the content of which is incorporated herein by reference in its entirety.

### TECHNICAL FIELD

The present technology pertains to Ultra-Wide band wireless communication network, and more specifically, to signaling procedures for enabling co-existence of omlox and FiRa Ultra-Wide Band standards.

### BACKGROUND

Ultra-Wide Band (UWB) is a wireless technology that enables accurate indoor positioning and location-based services, up to 10 cm precise, even in challenging indoor environments which makes it ideally suited to enable real-time measurement of location, distance, and direction, while also supporting two-way communication.

IEEE 802.15.4 standard for wireless communication defines the operations of UWB. Two widely adopted UWB-based standards include omlox and Fine Ranging Consortium (FiRa).

omlox is an open and interoperable location-tracking standard designed for industrial applications. It enables seamless integration of various tracking technologies, including Ultra-Wideband (UWB), GPS, RFID, 5G, and Wi-Fi, to create a unified location-tracking ecosystem.

FiRa Consortium is an industry alliance focused on promoting the adoption and interoperability of Ultra-Wideband (UWB) technology for secure, high-precision location-based services. FiRa's primary goal is to ensure seamless UWB integration across various consumer and enterprise applications.

FiRa is consumer-driven, focusing on secure, short-range communication for devices like smartphones, smart access, and IoT applications. omlox is industrial-focused, enabling RTLS and tracking solutions for logistics, warehouses, and factories. FiRa signaling procedures are more opportunistic in nature and hence more secure while omlox signaling procedures are more deterministic.

Co-existence and operations of FiRa and omlox systems can be challenging with signaling collisions likely.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example environment operating based on FiRa (UWB) standard according to some aspects of the present disclosure.

FIG. 2 illustrates an example environment operating based on omlox (UWB) standard according to some aspects of the present disclosure.

FIG. 3 illustrates an example of an omlox ranking block according to some aspects of the present disclosure.

FIG. 4 illustrates an example of a FiRa ranging round according to some aspects of the present disclosure.

FIG. 5 illustrates example ranging block setups for FiRa, omlox, and FiRa-omlox hybrid anchors for a hybrid FiRa-omlox environment according to some aspects of the present disclosure.

FIG. 6 illustrates an example method of synchronizing ranging blocks in a hybrid FiRa-omlox environment according to some aspects of the present disclosure.

FIG. 7 shows an example of a computing system according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

It should be noted that throughout the present disclosure, references are being made to omlox and FiRa, not to be limited to the specific organizations per se, but simply as two current exemplary UWB specifications/standards. The present disclosure is not limited thereto and may encompass any future organizations that provide UWB specifications, with one or more being focused on industrial environment and applications (an example of which is provided through omlox specification), and others in consumer-drive, etc. (an example of which is provided through FiRa consortium).

### Overview

In one aspect, a method includes determining, for each of a plurality of ranging blocks to be used by one of a plurality of anchors in a hybrid FiRa-omlox environment, a corresponding rounding split between corresponding idle ranging rounds and active ranging rounds, the plurality of anchors including at least one FiRa-compatible anchor and at least one omlox-compatible anchor; generating each of the plurality of ranging blocks using the corresponding rounding split; and sending the plurality of ranging blocks to the plurality of anchors.

In another aspect, a first ranging block of the plurality of ranging blocks is for the at least one omlox-compatible anchor with the corresponding idle ranging rounds and the corresponding active ranging rounds interleaved.

In another aspect, a second ranging block of the plurality of ranging blocks is for the at least one FiRa-compatible anchor, the corresponding idle ranging rounds of the second ranging block coinciding with the corresponding active ranging rounds of the first ranging block, and the corresponding active ranging rounds of the second ranging block coinciding with the corresponding idle ranging rounds of the first ranging block.

In another aspect, a first ranging block of the plurality of ranging blocks is for the at least one omlox-compatible anchor, a second ranging block of the plurality of ranging blocks is for the at least one FiRa-compatible anchor, and the rounding split for the first ranging block and the second ranging block is uneven.

In another aspect, the plurality of anchors includes at least one FiRa-omlox hybrid anchor, and the corresponding ranging block of the at least one FiRa-omlox hybrid anchor is a combination of a FiRa ranging block and an omlox ranging block.

In another aspect, the corresponding rounding split is determined based on a number of FiRa-compatible device and omlox-compatible devices and associated expected accuracies, in the hybrid FiRa-omlox environment.

In another aspect, the plurality of anchors includes one or more of a mobile device or an access point.

In one aspect, an apparatus includes one or more memories having computer-readable instructions stored thereon; and one or more processors. The one or more processors are configured to determine, for each of a plurality of ranging blocks to be used by one of a plurality of anchors in a hybrid FiRa-omlox environment, a corresponding rounding split between corresponding idle ranging rounds and active ranging rounds such, the plurality of anchors including at least one FiRa-compatible anchor and at least one omlox-compatible anchor; generate each of the plurality of ranging blocks using the corresponding rounding split; and send the plurality of ranging blocks to the plurality of anchors.

In one aspect, one or more non-transitory computer-readable media include computer-readable instructions, which when executed by one or more processors of a device, cause the device to determine, for each of a plurality of ranging blocks to be used by one of a plurality of anchors in a hybrid FiRa-omlox environment, a corresponding rounding split between corresponding idle ranging rounds and active ranging rounds such, the plurality of anchors including at least one FiRa-compatible anchor and at least one omlox-compatible anchor; generate each of the plurality of ranging blocks using the corresponding rounding split; and send the plurality of ranging blocks to the plurality of anchors.

### Example Embodiments

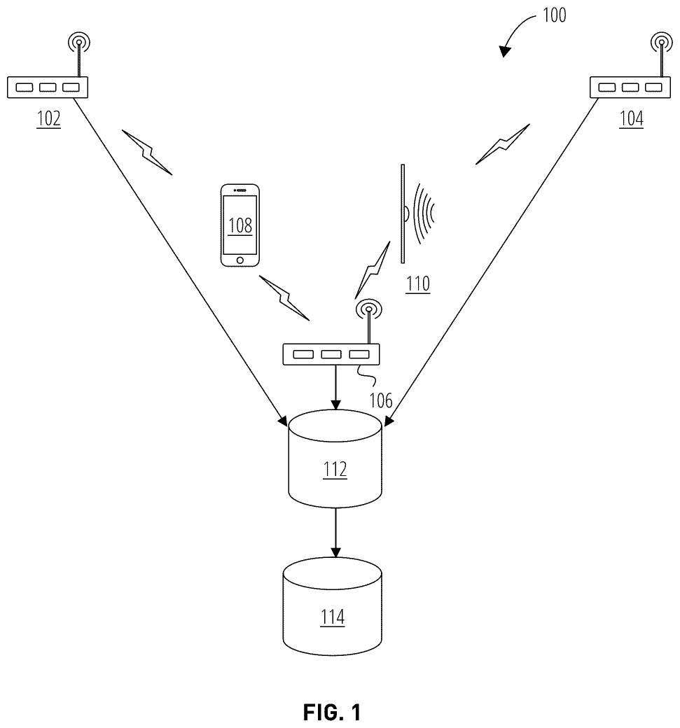

FIG. 1 illustrates an example environment operating based on FiRa (UWB) standard, according to some aspects of the present disclosure.

In one example, environment 100 (which may also be referred to as an ecosystem or architecture) includes a plurality of UWB anchors such as anchor 102, anchor 104, and anchor 106, a plurality of tags such as tag 108 and tag 110, a positioning server such as server 112, and an application layer server such as application layer server 114. It should be noted that environment 100 may include any other known or to be developed component such as additional servers, communication components, etc. Furthermore, the number of various components such as anchors and tags are not limited to that shown in FIG. 1 and may be more or less.

Each one of anchor 102, anchor 104, and anchor 106 may be a fixed device capable of emitting and receiving (transmitting and receiving) UWB signals. In one example, such UWB signals may be utilized to determine a distance between a given anchor and a given tag as will be described in more detail below. Each of anchor 102, anchor 104, and anchor 106 may be an access point (AP), a UWB base station, and/or any other device capable of transmitting and receiving UWB signals and communicating with co-located and/or cloud-based servers such as server 112 and application layer server 114.

A tag may be any device that includes a UWB transceiver capable of communicating with an anchor. In non-limiting example of FIG. 1, tag 108 is a mobile device and tag 110 may be any known or to be developed UWB tag that may be wearable and capable of tracking assets, people, vehicles and equipment in various industrial and retail settings, etc.

Server 112 can be referred to as a positioning server. Server 112 can be any on-premise and/or cloud-based server that is capable of communicating with anchor 102, anchor 104, and/or anchor 106. For example, server 112 can receive raw data from anchor 102, anchor 104, and/or anchor 106 and process the data to determine location of tag 108 and/or tag 110. As will be described below, server 112 may also function as a central synchronizer, a central orchestrator, or a central reference generator to coordinate ranging blocks for FiRa and omlox systems.

Server 112 may be implemented using any known or to be developed Real-Time Location Service (RTLS) server, a UWB server, any known or to be developed public, provider, or hybrid cloud server, etc.

Application layer server 114 may be a server executing software application to provide real-time location data to end users and applications. Such software application may be any known or to be developed application including, but not limited to, commercially available asset tracking systems, indoor navigation applications, etc.

In order to determine a location of a tag, each anchor (e.g., anchor 102) may receive a signal transmission (e.g., a beacon or a pulse) from a tag such as tag 108. Using Time Difference of Arrival (TDoA) or Two-Way Ranging (TWR), an anchor can determine a distance between that anchor and any tag with which the anchor communicates. The TDoA can be an Up Link TDOA (UL-TDoA) or a Down Link TDoA (DL-TDoA).

Determining a distance between an anchor and a tag is made possible using a ranging block. Ranging blocks are structured time intervals during which devices perform distance measurements (ranging) to determine positions. Each anchor (e.g., anchor 102, anchor 104, and anchor 106) and each tag (e.g., tag 108 and tag 110) has a ranging block. A ranging block can handle Time of Flight (ToF) or TDoA calculations for localization and ultimately location determination.

For example, using a ranging block, an anchor or a tag can send and receive UWB pulses and record timestamps associated with each. By measuring time delay between transmitted and received signals using techniques such as TWR, UL-TDoA, and/or DL-TDoA, a distance between the anchor and the tag can be determined. TWR is a technique whereby round-trip time between a tag and an anchor is measured using transmitted and received pulses. UL-TDoA and DL-TDoA are techniques whereby a difference in arrival time at multiple anchors is used to measure a distance between each anchor and a tag.

In order to accurately determine distances between anchors and tags, ranging blocks of anchors and/or tags are synchronized. This synchronization can be achieved via various techniques including, but not limited to, a shared clock signal by anchors, periodic UWB broadcast messages (can be broadcasted by server 112 or a designated master anchor (e.g., one of anchor 102, anchor 104, and anchor 106), etc.

A ranging block may include several physical components including, but not limited to, a UWB transceiver, timing and clock synchronization unit, a signal processing unit, a data interface module, and a power management component. Specifications of a ranging block are defined by IEEE 802.15.4z specifications.

A ranging block may have a duration that refers to a time taken to complete a full ranging transaction between an anchor and a tag. The duration may be set according to the underlying ranging method used (e.g., TWR v. TDoA) and/or the required accuracy of location determination of assets (e.g., in a hospital v. a warehouse). For example, a duration of a ranging block may be set to 1 second. Each ranging block may include a plurality of ranging rounds. For instance, a ranging block can include 8 ranging rounds (4 active and 4 passive rounds), as will be further described below.

A ranging round is a complete cycle of message exchanges between a UWB tag and one or more UWB anchors to determine the distance (range) therebetween. Each ranging round consists of transmitting and receiving UWB pulses, recording timestamps, and performing distance calculations based on ToF and TDoA measurements.

Using distances determined by anchors and angle data from the anchors, server 112 can determine accurate position of a given tag, which can be forwarded to application layer server 114 to be displayed in real-time on a terminal for asset tracking, navigation, and/or any other relevant application.

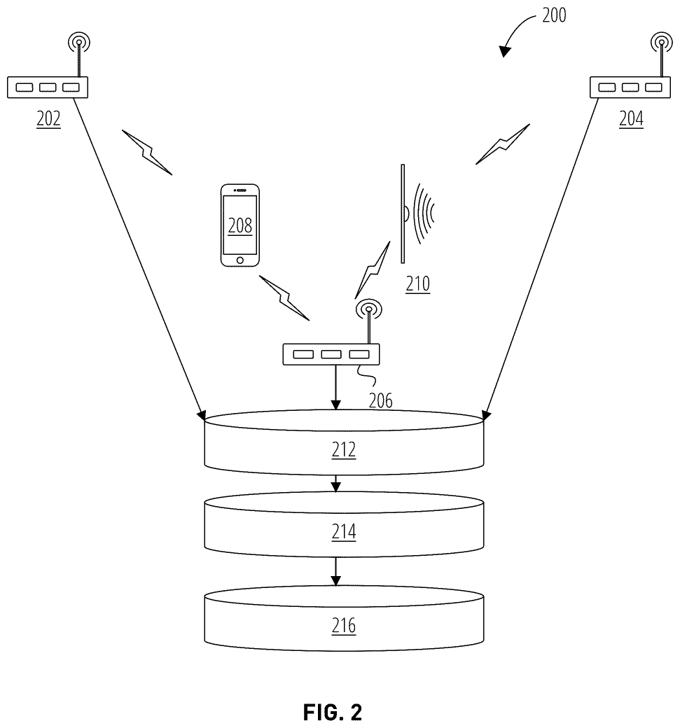

FIG. 2 illustrates an example environment operating based on omlox (UWB) standard, according to some aspects of the present disclosure.

In one example, environment 200 (which may also be referred to as an ecosystem or architecture) includes a plurality of UWB anchors such as anchor 202, anchor 204, and anchor 206, a plurality of tags such as tag 208 and tag 210, an omlox hub 212, a middleware server 214, and an application layer server 216. It should be noted that environment 200 may include any other known or to be developed component such as additional servers, communication components, etc. Furthermore, the number of various components such as anchors and tags is not limited to that shown in FIG. 2 and may be more or less.

Each one of anchor 202, anchor 204, and anchor 206 may be a fixed device capable of emitting and receiving (transmitting and receiving) UWB signals. In the context of an omlox environment, each of anchor 202, anchor 204, and anchor 206 may be referred to as a satellite or Full Blown Satellite (FBS). Anchor 202, anchor 204, and anchor 206 may form a UWB localization network with each receiving UWB signals from tag 208 and tag 210 to determine positions of each tag. omlox

Each of tag 208 and tag 210 may be a mobile UWB device attached to an asset such as a robot, a worker, a vehicle, etc. Tag 208 and tag 210 may be configured to transmit UWB pulses that are received by anchor 202, anchor 204, and/or anchor 206 for position calculation. Tag 208 and tag 210 may actively transmit (based on TDoA) or passively responding (based on TWR). Non-limiting examples of tag 108 and tag 210 include UWB tags for industrial tracking, Ubisense asset tracking tags, omlox-compatible wearable tags (e.g., by factory workers), etc.

omlox hub 212 may be an on-premise or cloud-based central processing component configured to collect position data from multiple anchors (e.g., anchor 202, anchor 204, and/or anchor 206), and standardize and distribute the location data for purposes such as cross-vendor compatibility. omlox hub 212 may further enable real-time interoperability across different UWB hardware manufacturers.

Middleware server 214 may be a real-time RTLS middleware that is run on an on-premise or cloud-based server. Middleware server 214 may include a software layer that integrates UWB location data with other tracking technologies (e.g., Bluetooth Low Energy (BLE), RFID, Global Positioning System (GPS), etc.). Middleware server 214 can perform data fusion and algorithm-based error correction according to any known or to be developed method. Middleware server 214 can provide Application Programming Interfaces (A Pls) to expose location data to enterprise applications. Non-limiting examples of middleware server 214 include, but are not limited to, Quuppa Intelligent Location System, Zebra MotionWorks RTLS Middleware, Ubisense SmartSpace, etc.

Application layer server 216 may be a front-end interface for end users (via their respective end terminals) to access real-time location data. Application layer server 216 can be accessed in the form of a dashboard, interactive analytics tool, or an automation software. Non-limiting examples of omlox-compatible applications available via application layer server 216 include, but are not limited to, Warehouse Management Systems (WMS), AGV/AMR Fleet Management Systems, Smart Factory Digital Twins, Indoor Navigation & Safety Alerts, etc.

In an omlox-based environment such as environment 200, determining locations of tags may be achieved as follows.

A tag (e.g., tag 208 and/or 210) may periodically transmit a signal (e.g., a BLINK signal) or respond to a poll from an anchor (e.g., anchor 202, anchor 204, and/or anchor 206). The tag can operate in an active mode or a passive mode.

Upon receiving such signal, the receiving anchor may timestamp the signal and record the arrival time of the signal. When using TDoA, the anchor timestamps the signal and forwards it to omlox hub 212. When using TWR, each anchor exchanges ranging messages with the tag to measure the round-trip time (RTT).

Thereafter, omlox hub 212 may process the time differences and determine the precise location of each tag according to any known or to be developed method. Middleware server 214 may further refine the location data through application of error correction and/or data fusion with location data from other technologies such as BLE, RFID, GPS, etc.

Determined location data may then be sent to application layer server 216 for asset tracking purposes via a dashboard, performing analytics, etc.

Similar to FiRa, omlox standard also utilizes ranging blocks and ranging rounds for synchronizing anchors, determining location of tags, etc.

Each omlox ranging block may be formed of 8 ranging rounds with 4 active rounds and 4 silent rounds of equal duration (e.g., 125 msec). The active and silent rounds may be interleaved.

As noted above, co-existence and operations of FiRa and omlox systems can be challenging with signaling collisions likely. FiRa and omlox both define DL-TDoA schemes for UWB (omlox with a focus on industrial environments and automation, and FiRa with a focus on general purpose devices such as smartphones, tablets, etc.).

In DL-TDoA (a One Way Ranging (OWR) mode), anchors exchange timed messages. A station (STA) (e.g., a device such as tag 108, tag 110, tag 208, tag 210, etc.) can listen to these messages and deduces its relative distance to the anchors from the time difference of arrival of the frames. The STA then computes its location using hyperbolic methods.

The omlox structure is different from the FiRa structure. As noted above, both define ranging blocks, subdivided into ranging rounds, each round being formed of slots. However, their structure is different, making co-existence difficult. In particular, the structure of an omlox ranging block is fixed (and includes different phases), while the structure of a FiRa block is more loosely defined. When both solutions are deployed near each other, collisions (and thus performance losses) will appear.

There needs to be a method to allow a DL-TDoA scheme that accommodates both approaches. Example embodiments presented below describe such methods.

In one example, a central entity, (e.g., a designated reference Anchor (e.g., a FiRa anchor such as one of anchor 102, anchor 104, and/or anchor 106 of FIG. 1, which may also be referred to as a Downlink Time Anchor (DT-anchor) or an FBS (e.g., an omlox FBS such as anchor 202, anchor 204, and/or anchor 206 of FIG. 2) as the central time reference for the entire network (e.g., environment 100 or environment 200). This central reference can generate a common ranging block structure and propagate synchronization information to all anchors. In one example, a single radio entity may act as the FBS and Reference DT anchor, or a central time reference orchestrates the actions of distinct radios, one acting as FBS and the other as Responder DT-Anchors.

The common ranging block structure for both FiRa and omlox may be as follows.

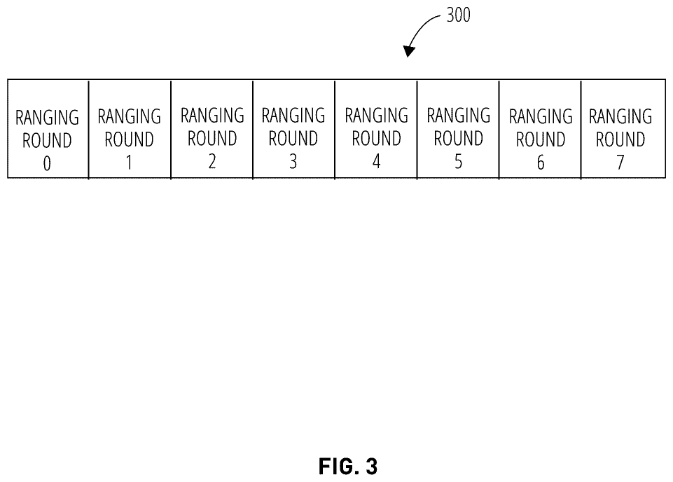

FIG. 3 illustrates an example of an omlox ranking block according to some aspects of the present disclosure.

omlox ranging Block 300 is formed of 8 ranging rounds 0-7 as shown. In one example, omlox ranging block 300 has a duration of 1 second with each ranging round being 125 msec. The duration of omlox ranging block 300 and the associated ranging rounds is not limited to 1 second and 125 msec respectively but may be set according to any known or to be developed methodology and/or empirical studies.

In one example, each ranging round includes 150 slots of 0.833 milliseconds each, totaling 125 msec per round. This configuration allows for up to eight ranging rounds per second, facilitating update rates of up to 8 Hz. Each ranging round is divided into multiple phases. For example, one phase can be an Extended Ranging Control Phase (xRCP) that includes 16 slots. XRCP may be assigned to an FSB that sequentially propagates synchronization signals across the network. Another phase can be an initiation phase having 32 slots. The initiation phase may be used by FSBs to transmit downlink ranging messages to tags. Another phase can be a response phase that includes 102 slots, and may be used by tags for transmission of uplink ranging messages.

In one example, 4 of the 8 ranging rounds in omlox ranging block 300 may be active rounds while the remaining 4 may be silent rounds. In one example and in order to provide a ranging block structure for co-existence and co-operability of omlox and FiRa systems, the central entity mentioned above (e.g., an omlox FBS) may interleave the active and silent rounds (e.g., 1 active round followed by 1 silent round as in ranging round 0 being an active round, ranging round 1 being a silent round, ranging round 2 being an active round, ranging round 3 being a silent round, and so forth). During a given silent round, omlox FBSs may be silent while in the active rounds, they may operate per omlox standards.

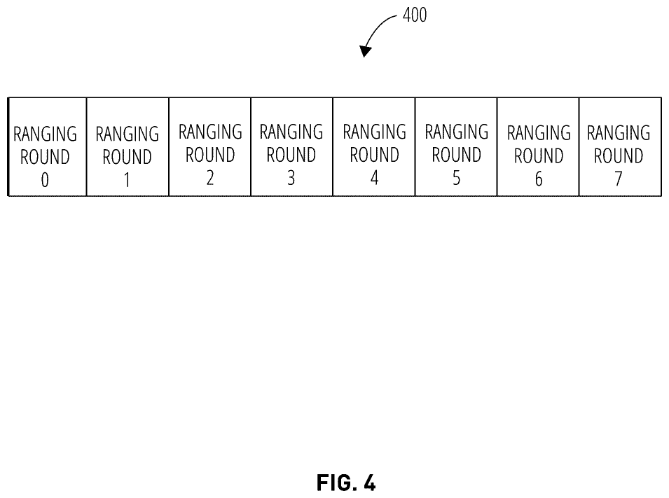

FIG. 4 illustrates an example of a FiRa ranging round according to some aspects of the present disclosure.

In order to enable co-existence and operation of omlox and FiRa systems, FiRa ranging block 400 may have a similar structure as omlox ranging block 300 in that FiRa ranging block 400 may have a fixed duration that is the same as the duration of omlox ranging block 300 (e.g., 1 second).

FiRa's ranging block structure is designed to support scalable and secure ranging, particularly in applications like public transportation fare collection and indoor navigation. A typical FiRa ranging block is divided into multiple ranging rounds, each containing several slots with durations typically around 1 to 2 milliseconds. Each active ranging round starts with an Initiator anchor sending a POLL message, followed by RESPONSE messages from Responder anchors. The exchange may optionally end with a FINAL message sent by the Initiator. Each message is sent on the slot time grid, with the Initiator anchor assigning slots for the Responder anchors to reply.

FiRa ranging block 400 may also have the same number of ranging rounds as omlox ranging block 300 (e.g., 8 rounds). However, an active FiRa ranging round may start when a silent omlox ranging round starts and vice-versa.

In another example, FiRa ranging rounds and omlox ranging rounds may be organized differently such that instead of having 1 active omlox ranging round coincide with 1 silent FiRa ranging round or vice-versa, an uneven number of active or silent ranging rounds of a FiRa and an omlox ranging round correspond to one another (e.g., 6 active omlox ranging rounds followed coinciding with 6 silent FiRa ranging rounds, followed by 2 silent omlox ranging rounds coinciding with 2 active FiRa ranging rounds).

As the central time reference initiates each round, local conditions may be used to define the round split between FiRa and omlox ranging blocks. For example, the split may be determined based on the number of omlox devices and the number of FiRa devices requiring ranging, the expected accuracy needed for each type of tag (more frequent rounds for more accurate location), etc.

In example embodiments described above with reference to FIG. 1 and FIG. 2, a FiRa environment (e.g., environment 100) and an omlox environment (e.g., environment 200) are described separately. However, it is possible for an environment to have both systems operating therein (which may be referred to as a hybrid FiRa-omlox environment). In other words, there may be various scenarios in which omlox-compatible tags and anchors co-exist (and hence operate) along with FiRa-compatible tags and anchors. In such scenarios, an anchor may be a FiRa-compatible anchor (e.g., anchor 102, anchor 104, and anchor 106) or an omlox-compatible FBS (e.g., anchor 202, anchor 204, and anchor 206). However, the present disclosure is not limited thereto and an anchor may be a FiRa-omlox hybrid anchor.

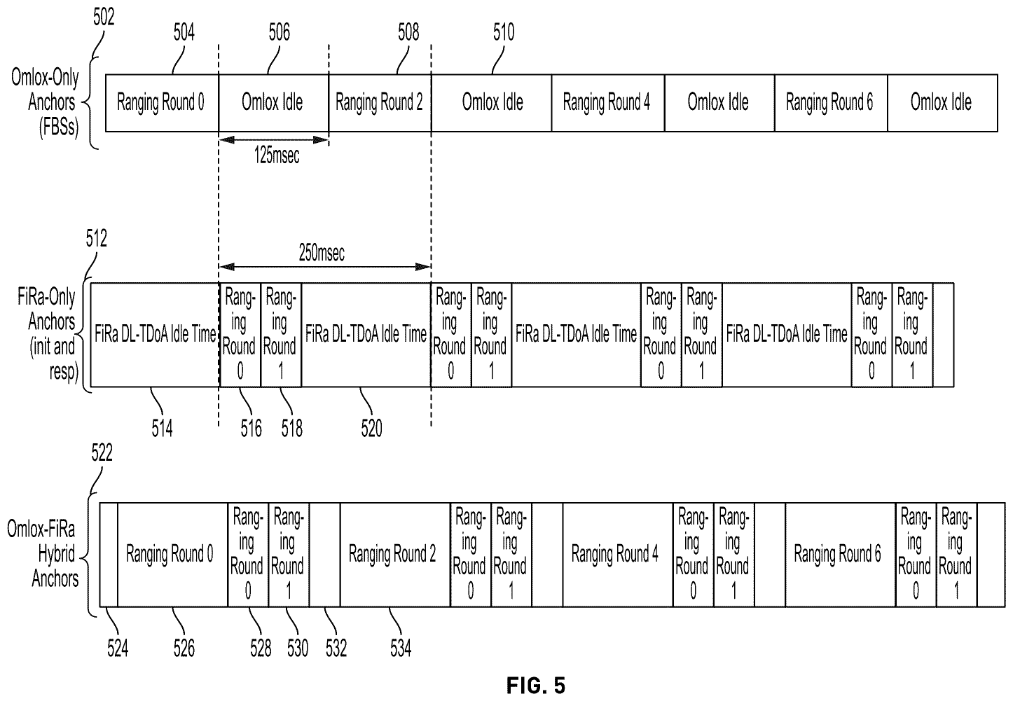

FIG. 5 illustrates example ranging block setups for FiRa, omlox, and FiRa-omlox hybrid anchors for a hybrid FiRa-omlox environment according to some aspects of the present disclosure.

Ranging block 502 is an example omlox ranging block that a central entity may generate and send to omlox-compatible anchors (e.g., anchor 202, anchor 204, and/or anchor 206) in such a hybrid FiRa-omlox environment. As described above, ranging block 502 may have active ranging round 504 followed by idle (silent) ranging round 506, followed by active ranging round 508, followed by idle ranging round 510, and so forth.

Ranging block 502 is an example FiRa ranging block that a central entity may generate and send to FiRa-compatible anchors (e.g., anchor 102, anchor 104, and/or anchor 106) in such a hybrid FiRa-omlox environment. As described above, ranging block 512 may have FiRa DL-TDoA idle ranging round 514 that corresponds to active ranging round 504. Idle ranging round 514 may be followed by an active FiRa ranging round formed of ranging round 516 and ranging round 518, which is then followed by idle ranging round 520. As shown in FIG. 5, in one example, duration of ranging round 516, ranging round 518 and idle ranging round 520 is the same as the combination of idle ranging round 506 and active ranging round 508 of ranging block 502 (e.g., 250 msec). However, the active FiRa ranging round that is equal to ranging round 516 and ranging round 518 is shorter than idle ranging round 506 (e.g., less than 125 msec).

Ranging block 522 is an example FiRa-omlox hybrid ranging block that a central entity may generate and send to a FiRa-omlox hybrid anchor (e.g., can be any one of anchor 102, anchor 104, anchor 106, anchor 202, anchor 204, anchor 206, or any other anchor not shown in FIG. 1 and FIG. 2) in such a hybrid FiRa-omlox environment. As described above, ranging block 522 may have an initial FiRa idle time 524 followed by omlox active ranging round 526 that corresponds to active ranging round 504 of ranging block 502. This is followed by active ranging round 528 and ranging round 530 that correspond to active ranging round 526 and active ranging round 528 of ranging block 512. This arrangement is repeated again with FiRa idle time 532, omlox active ranging round 534, and so forth.

In example embodiments described above, a central entity (e.g., an anchor) may determine and signal the ranging block structures in-band. However, the present disclosure is not limited thereto. For instance, the central entity can signal the ranging block structures to relevant anchors out-of-band using, for example, a Wi-Fi connection. Using a Wi-Fi connection, an access point (which is an example of an anchor) can signal support for UWB transmissions.

In one example, using out-of-band signaling, the anchor can include an information element about the block structure (e.g. 10101010 to express FiRa, omlox, FiRa, omlox, FiRa, omlox, FiRa, omlox). The information element may also include the block duration, if it is not set at a configurable default value, along with the round duration, if it is not set at a configurable default value. The information element may also include the block, or each round nature (for example 1, for DL-TDoA), when the anchor supports more than one type of exchange (e.g. DL-TDoA, UL-TDoA, TWR, etc.). Additionally, the element may include the time at which the next block will start.

In another example, over UWB transmissions, a FiRa anchor response message (e.g., to the reference DT anchor poll message) includes a drift information (a-la omlox), that allows neighboring anchors to compute their neighbor relative drifts. This information allows several anchors, at the edge between 2 clusters, to repeat one cluster reference DT anchor messages to the next cluster, while each member of the next cluster (hearing two or more repeaters) can use this information to deduce a mean time drift between both repeating anchors (and thus better synchronize the next cluster time with the first cluster time).

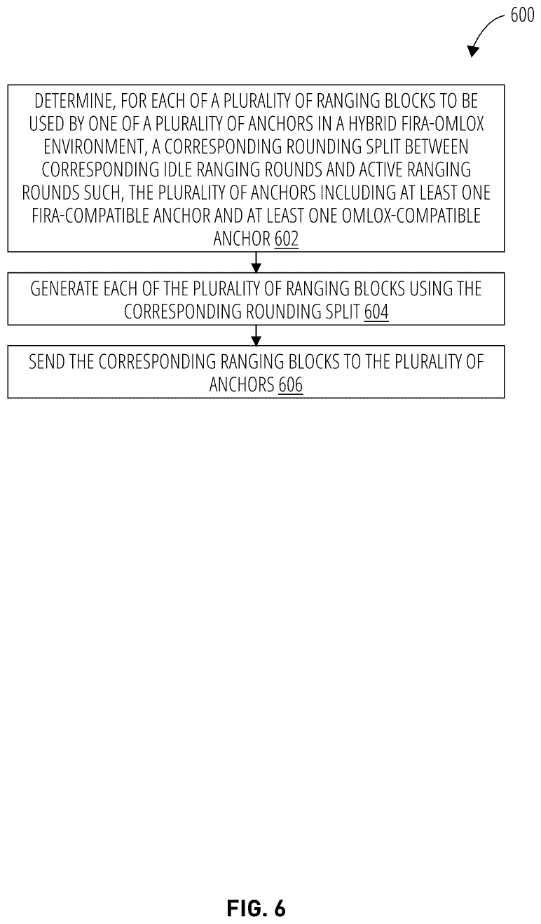

FIG. 6 illustrates an example method of synchronizing ranging blocks in a hybrid FiRa-omlox environment according to some aspects of the present disclosure.

Steps of method 600 will be described from the perspective of a central entity. As noted above, a central entity can be any one of anchor 102, anchor 104, anchor 106, anchor 202, anchor 204, anchor 206, and/or any other component described with reference to FIGS. 1 and 2 such as server 112, omlox hub 212, middleware server 214, etc.

In block 602, central entity (may also be referred to as an apparatus, controller, an anchor, etc.) may determine, for each of a plurality of ranging blocks to be used by one of a plurality of anchors in a hybrid FiRa-omlox environment, a corresponding rounding split between corresponding idle ranging rounds and active ranging rounds. Non-limiting examples of plurality of ranging blocks can include ranging block 502, ranging block 512, and/or ranging block 522 described above with reference to FIG. 5. In one example, a specific ranging block may be determined for every single anchor present in a hybrid FiRa-omlox environment.

A corresponding rounding split may refer to the arrangement of idle and active ranging rounds within a given ranging block such as omlox ranging block 300, FiRa ranging block 400, etc.

As noted above, splitting of ranging rounds in a given ranging block may be uneven (e.g., 6 active ranging rounds followed by two idle ranging rounds for an omlox-compatible ranging block while there may be 6 idle ranging rounds followed by two active ranging rounds for a FiRa-compatible ranging block). The splitting of ranging rounds may be based on any known or to be developed factors and/or empirical studies such as number of omlox-compatible and FiRa-compatible devices in a hybrid FiRa-omlox environment, required location accuracy for each such device, etc.

At block 604, central entity may generate each of the plurality of ranging blocks using the corresponding rounding split. The plurality of ranging blocks may be generated as described above with reference to FIG. 5.

In one example, the plurality of anchors includes at least one FiRa-compatible anchor and at least one omlox-compatible anchor. For example, a first ranging block (e.g., ranging block 502) of the plurality of ranging blocks is for the at least one omlox-compatible anchor with the corresponding idle ranging rounds (e.g., ranging round 506 and ranging round 510) and the corresponding active ranging rounds (e.g., ranging round 504 and ranging round 508) interleaved as described above with reference to FIG. 5.

In another example, a second ranging block (e.g., ranging block 512) of the plurality of ranging blocks is for the at least one FiRa-compatible anchor. In one example, the corresponding idle ranging rounds (e.g., ranging round 514 and ranging round 520) of the second ranging block coincides (overlap partially or completely) with one of the corresponding active ranging rounds (e.g., ranging round 504 and ranging round 508) of the first ranging block, and the corresponding active ranging rounds (e.g., ranging round 516 and ranging round 518) of the second ranging block coincide (overlap partially or completely) with one of the corresponding idle ranging rounds (e.g., ranging round 506 and ranging round 510) of the first ranging block.

In another example, a third ranging block (e.g., ranging block 522) of the plurality of ranging blocks is for a FiRa-omlox hybrid anchor with idle and active ranging rounds interleaved (combined) within the same ranging block (e.g., ranging block 522 as shown in FIG. 5), with each idle ranging round and active ranging round of ranging block 522 coinciding (overlapping partially or completely) with one of a corresponding idle ranging round or active ranging round of ranging block 502 and ranging block 512.

According, the first, the second, and the third ranging blocks may be said to have been synchronized to prevent signaling collision when locations of omlox-compatible and FiRa-compatible devices are to be determined in a hybrid FiRa-omlox environment.

Once the ranging blocks are generated, at block 606, central entity may send (transmit) the corresponding ranging blocks for each type of anchor to the corresponding anchor in the hybrid FiRa-omlox environment.

Through implementation of example embodiments described above, UWB DL-TDoA ranging in hybrid FiRa-omlox environments is made possible. Such method is advantageous, because native omlox and native FiRa DL-TDoA methods are incompatible, with the result that one device in the environment where the other technique is implemented is enough to destroy the other technique's efficiency. The proposed method allows for coexistence, thus allowing (for example) a smartphone in an omlox environment without breaking the omlox DL-TDoA function (and vice versa).

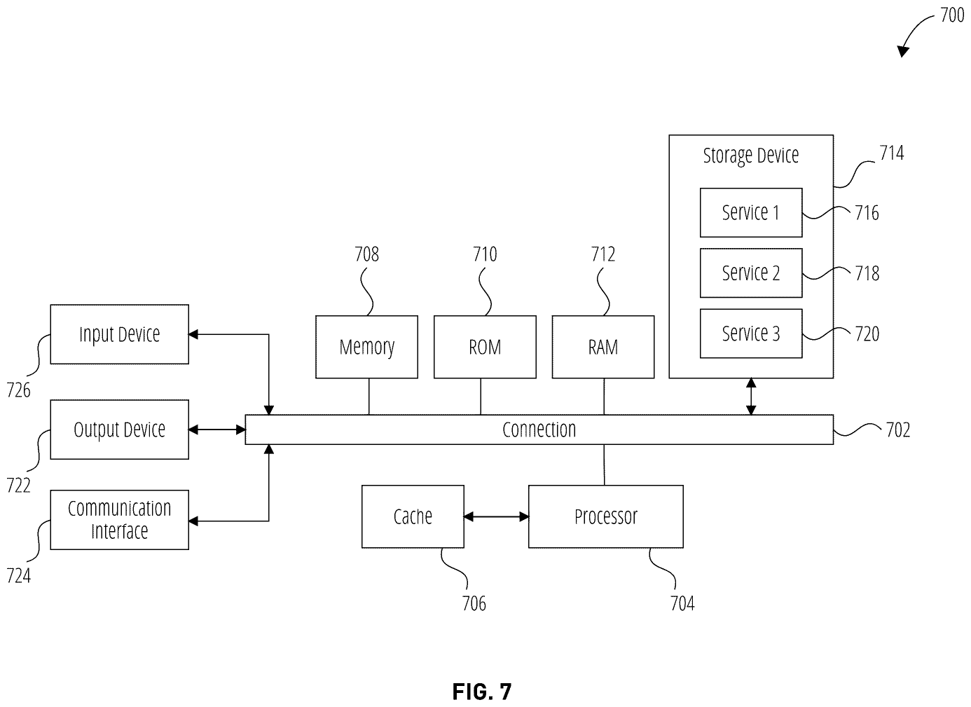

FIG. 7 shows an example of a computing system according to some aspects of the present disclosure.

Computing system 700 can be for example any computing device making up components shown in FIGS. 1 and 2 and described above including, but not limited to, anchor 102, anchor 104, 106, tag 108, tag 110, server 112, application layer server 114, anchor 202, anchor 204, anchor 206, tag 208, tag 210, omlox hub 212, middleware server 214, application layer server 216, or any component thereof in which the components of the system are in communication with each other using connection 702. Connection 702 can be a physical connection via a bus, or a direct connection into processor 704, such as in a chipset architecture. Connection 702 can also be a virtual connection, networked connection, or logical connection.

In some examples, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) such as processor 704 and connection 702 that couples various system components including system memory 708, read-only memory (ROM) such as ROM 710 and random access memory (RAM) such as RAM 712 to processor 704. Computing system 700 can include a cache of high-speed memory 706 connected directly with, in close proximity to, or integrated as part of processor 704.

Processor 704 can include any general purpose processor and a hardware service or software service, such as service 716, service 718, and service 720 stored in storage device 714, and configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some examples, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
determining, for each of a plurality of ranging blocks to be used by one of a plurality of anchors in a hybrid FiRa-omlox environment, a corresponding rounding split between corresponding idle ranging rounds and active ranging rounds, the plurality of anchors including at least one FiRa-compatible anchor and at least one omlox-compatible anchor;
generating each of the plurality of ranging blocks using the corresponding rounding split; and
sending the plurality of ranging blocks to the plurality of anchors.

2. The method of claim 1, wherein a first ranging block of the plurality of ranging blocks is for the at least one omlox-compatible anchor with the corresponding idle ranging rounds and the corresponding active ranging rounds interleaved.

3. The method of claim 2, wherein,
a second ranging block of the plurality of ranging blocks is for the at least one FiRa-compatible anchor,
the corresponding idle ranging rounds of the second ranging block coinciding with the corresponding active ranging rounds of the first ranging block, and
the corresponding active ranging rounds of the second ranging block coinciding with the corresponding idle ranging rounds of the first ranging block.

4. The method of claim 1, wherein,
a first ranging block of the plurality of ranging blocks is for the at least one omlox-compatible anchor,
a second ranging block of the plurality of ranging blocks is for the at least one FiRa-compatible anchor, and
the corresponding rounding split for the first ranging block and the second ranging block is uneven.

5. The method of claim 1, wherein the plurality of anchors includes at least one FiRa-omlox hybrid anchor, and the corresponding ranging block of the at least one FiRa-omlox hybrid anchor is a combination of a FiRa ranging block and an omlox ranging block.

6. The method of claim 1, wherein the corresponding rounding split is determined based on a number of FiRa-compatible device and omlox-compatible devices and associated expected accuracies, in the hybrid FiRa-omlox environment.

7. The method of claim 1, wherein the plurality of anchors includes one or more of a mobile device or an access point.

8. An apparatus comprising:
one or more memories having computer-readable instructions stored therein; and
one or more processors configured to execute the computer-readable instructions to:
determine, for each of a plurality of ranging blocks to be used by one of a plurality of anchors in a hybrid FiRa-omlox environment, a corresponding rounding split between corresponding idle ranging rounds and active ranging rounds such, the plurality of anchors including at least one FiRa-compatible anchor and at least one omlox-compatible anchor;
generate each of the plurality of ranging blocks using the corresponding rounding split; and
send the plurality of ranging blocks to the plurality of anchors.

9. The apparatus of claim 8, wherein a first ranging block of the plurality of ranging blocks is for the at least one omlox-compatible anchor with the corresponding idle ranging rounds and the corresponding active ranging rounds interleaved.

10. The apparatus of claim 9, wherein,
a second ranging block of the plurality of ranging blocks is for the at least one FiRa-compatible anchor,
the corresponding idle ranging rounds of the second ranging block coinciding with the corresponding active ranging rounds of the first ranging block, and
the corresponding active ranging rounds of the second ranging block coinciding with the corresponding idle ranging rounds of the first ranging block.

11. The apparatus of claim 8, wherein,
a first ranging block of the plurality of ranging blocks is for the at least one omlox-compatible anchor,
a second ranging block of the plurality of ranging blocks is for the at least one FiRa-compatible anchor, and
the corresponding rounding split for the first ranging block and the second ranging block is uneven.

12. The apparatus of claim 8, wherein the plurality of anchors includes at least one FiRa-omlox hybrid anchor, and the corresponding ranging block of the at least one FiRa-omlox hybrid anchor is a combination of a FiRa ranging block and an omlox ranging block.

13. The apparatus of claim 8, wherein the corresponding round split is determined based on a number of FiRa-compatible devices and omlox-compatible devices and associated expected accuracies, in the hybrid FiRa-omlox environment.

14. The apparatus of claim 8, wherein the plurality of anchors includes one or more of a mobile device or an access point.

15. One or more non-transitory computer-readable media comprising computer-readable instructions, which when executed by one or more processors of a device, cause the device to:
determine, for each of a plurality of ranging blocks to be used by one of a plurality of anchors in a hybrid FiRa-omlox environment, a corresponding rounding split between corresponding idle ranging rounds and active ranging rounds such, the plurality of anchors including at least one FiRa-compatible anchor and at least one omlox-compatible anchor;
generate each of the plurality of ranging blocks using the corresponding rounding split; and
send the plurality of ranging blocks to the plurality of anchors.

16. The one or more non-transitory computer-readable media of claim 15, wherein a first ranging block of the plurality of ranging blocks is for the at least one omlox-compatible anchor with the corresponding idle ranging rounds and the corresponding active ranging rounds interleaved.

17. The one or more non-transitory computer-readable media of claim 16, wherein,
a second ranging block of the plurality of ranging blocks is for the at least one FiRa-compatible anchor,
the corresponding idle ranging rounds of the second ranging block coinciding with the corresponding active ranging rounds of the first ranging block, and
the corresponding active ranging rounds of the second ranging block coinciding with the corresponding idle ranging rounds of the first ranging block.

18. The one or more non-transitory computer-readable media of claim 15, wherein,
a first ranging block of the plurality of ranging blocks is for the at least one omlox-compatible anchor,
a second ranging block of the plurality of ranging blocks is for the at least one FiRa-compatible anchor, and
the corresponding rounding split for the first ranging block and the second ranging block is uneven.

19. The one or more non-transitory computer-readable media of claim 15, wherein the plurality of anchors includes at least one FiRa-omlox hybrid anchor, and the corresponding ranging block of the at least one FiRa-omlox hybrid anchor is a combination of a FiRa ranging block and an omlox ranging block.

20. The one or more non-transitory computer-readable media of claim 15, wherein the corresponding round split is determined based on a number of FiRa-compatible devices and omlox-compatible devices and associated expected accuracies, in the hybrid FiRa-omlox environment.
